(19) United States
(12) Patent Application Publication
(10) Pub. No.: US 2017/0101340 A1
(43) Pub. Date: Apr. 13, 2017

(54) ADHESIVE LAYER-EQUIPPED TRANSPARENT PLATE AND ADHESIVE LAYER

(71) Applicant: Asahi Glass Company, Limited, Chiyoda-ku (JP)

(72) Inventors: Atsushi INOUE, Chiyoda-ku (JP); Isao YAMAMOTO, Chiyoda-ku (JP); Kyohei HASHIMOTO, Chiyoda-ku (JP); Hitoshi MISHIRO, Chiyoda-ku (JP); Tomohiro TAKANO, Chiyoda-ku (JP); Hiroshi SAKAMOTO, Chiyoda-ku (JP); Satoshi OKI, Chiyoda-ku (JP); Junichi KAKUTA, Chiyoda-ku (JP); Takashi SHIBUYA, Chiyoda-ku (JP)

(73) Assignee: Asahi Glass Company, Limited, Chiyoda-ku (JP)

(21) Appl. No.: 15/385,175

(22) Filed: Dec. 20, 2016

Related U.S. Application Data
(63) Continuation of application No. PCT/JP2015/075106, filed on Sep. 3, 2015.

(30) Foreign Application Priority Data
Sep. 5, 2014 (JP) 2014-180986

(51) Int. Cl. C03C 17/32; C09J 7/02; C03C 21/00

(52) U.S. Cl. CPC C03C 17/32; C03C 21/002; C09J 7/026; C09J 2400/143; C09J 151/08

(57) ABSTRACT

To provide an adhesive layer-equipped transparent plate, which satisfies both visibility and impact resistance, and which is suitable for protection of an in-vehicle display device. The adhesive layer-equipped transparent plate according to the present invention comprises a transparent plate and an adhesive layer provided on one surface of the transparent plate. The transparent plate is a plate glass having a plate thickness of from 0.4 to 3.0 mm. The adhesive layer has a storage shear modulus of at most 30 MPa at a temperature of 25° C. and at a frequency of 1 Hz, a storage shear modulus of at least 50 MPa at a temperature of 25° C. and at a frequency of 40 kHz, and a loss tangent tanδ of at least 0.1 at a temperature of 25° C. and at a frequency of 40 kHz.

### TECHNICAL FIELD

The present invention relates to an adhesive layer-equipped transparent plate and an adhesive layer, and more particularly relates to an adhesive layer-equipped transparent plate and an adhesive layer suitable for protection of an in-vehicle display device.

### BACKGROUND ART

Heretofore, in order to protect a display panel of a display device, a transparent protective member covering the display surface (display area) of the display panel has been used. As such a protective member for protecting a display device, for example, in Patent Document 1, an adhesive layer-equipped transparent plate having an adhesive layer formed on the surface is disclosed.

### PRIOR ART DOCUMENT

### Patent Document

Patent Document 1: WO 2011/148990

### DISCLOSURE OF INVENTION

### Technical Problem

In a vehicle such as an automobile, a display device such as a car navigation device (hereinafter referred to also as an “in-vehicle display device”) is mounted. The type of an in-vehicle display device may, for example, be an on-dash type installed outside a dashboard, or an in-dash type embedded in a dashboard.

Also in such an in-vehicle display device, a transparent protective member such as a film or glass is used from the viewpoint of protection of the display panel, but in recent years, from the viewpoint of texture, use of a glass protective member (a cover glass) rather than a film has been desired. Further, among the glass, laminated glass tends to be thick and thus is liable to a design problem, and also the cost is high, and therefore, use of tempered glass is desired.

Whereas, with respect to an adhesive layer for bonding a cover glass to a display device, if a proper resin is not selected for the image display portion, display failure is likely to occur. Particularly, in the case of an in-vehicle display device mounted on a vehicle, as is different from a stationary display device, of which the installation position is unchangeable, because the direction of light striking the display surface (display area), etc. will change rapidly, the problem of display failure tends to be larger.

Further, from the viewpoint of safety, the cover glass for an in-vehicle display device is required to be not broken even if hit by the occupant's head, etc. when a collision accident of the vehicle occurs.

Of course, also in a stationary type display device such as a liquid crystal television, a cover glass to be used, is required to have a strength assumed to be durable against an impact due to a flying object or dropping of the display device itself.

However, the impact due to a collision accident, is much larger in energy than an impact assumed to be put on a conventional cover glass for a stationary type display device or a portable display terminal, etc., and therefore, a high impact resistance is required.

Accordingly, a protective member structure is required for an in-vehicle display device which is free from display failure and which has high safety.

The present invention has been made in view of the above, and it is an object of the present invention to provide an adhesive layer-equipped transparent plate and an adhesive layer, suitable for an in-vehicle display device, whereby both visibility and impact resistance are satisfied.

### Solution to Problem

As a result of extensive studies conducted in order to accomplish the above object, the present inventors have found that when an adhesive layer-equipped transparent plate satisfies certain conditions, both visibility and impact resistance will be excellent, and thus have accomplished the present invention.

An adhesive layer-equipped transparent plate according to an embodiment of the present invention comprises a transparent plate and an adhesive layer provided on one surface of the transparent plate, wherein the transparent plate is a plate glass having a plate thickness of from 0.4 to 3.0 mm, and the adhesive layer has a storage shear modulus of at most 30 MPa at a temperature of 25° C. and at a frequency of 1 Hz, a storage shear modulus of at least 50 MPa at a temperature of 25° C. and at a frequency of 40 kHz, and a loss tangent tanδ of at least 0.1 at a temperature of 25° C. and at a frequency of 40 kHz.

Further, an adhesive layer-equipped transparent plate according to another embodiment of the present invention comprises a transparent plate and an adhesive layer provided on one surface of the transparent plate, wherein the transparent plate is a plate glass having a plate thickness of from 0.6 to 3.0 mm, and the adhesive layer has a storage shear modulus of at most 30 MPa at a temperature of 25° C. and at a frequency of 1 Hz, a storage shear modulus of at least 50 MPa at a temperature of 25° C. and at a frequency of 40 kHz, and a loss tangent tanδ of at least 0.1 at a temperature of 25° C. and at a frequency of 40 kHz.

Further, an adhesive layer according to an embodiment of the present invention is an adhesive layer capable of bonding a transparent plate and a display device, which has a storage shear modulus of at most 30 MPa at a temperature of 25° C. and at a frequency of 1 Hz, a storage shear modulus of at least 50 MPa at a temperature of 25° C. and at a frequency 40 kHz, and a loss tangent tanδ of at least 0.1 at a temperature of 25° C. and at a frequency of 40 kHz.

### Advantageous Effects of Invention

According to the present invention, it is possible to provide an adhesive layer-equipped transparent plate and an adhesive layer, which satisfy both visibility and impact resistance.

### BRIEF DESCRIPTION OF DRAWINGS

FIG. 1 is a schematic cross-sectional view showing an adhesive layer-equipped transparent plate in one embodiment of the present invention.

FIG. 2 is a schematic plan view showing the adhesive layer-equipped transparent plate in one embodiment of the present invention.

FIG. 3 is a schematic cross-sectional view showing an in-vehicle display device having the adhesive layer-equipped transparent plate in one embodiment of the present invention bonded.

FIG. 4 is a schematic cross-sectional view illustrating a method for producing the adhesive layer-equipped transparent plate in one embodiment of the present invention.

FIG. 5 is a perspective view schematically showing a state before peeling by a tensile test.

FIG. 6 is a perspective view schematically showing a state after peeling by the tensile test.

FIG. 7 is a perspective view showing a test specimen.

FIG. 8 is a cross-sectional view along line A-A in FIG. 7.

FIG. 9 is a plan view showing the test specimen.

### DESCRIPTION OF EMBODIMENTS

Hereinafter, preferred embodiments of the adhesive layer-equipped transparent plate of the present invention will be explained with reference to the accompanying drawings, but it should be understood that the present invention is by no means limited to the following embodiments, and it is possible to add various modifications and substitutions to the following embodiments without departing from the scope of the present invention.

### Adhesive Layer-Equipped Transparent Plate

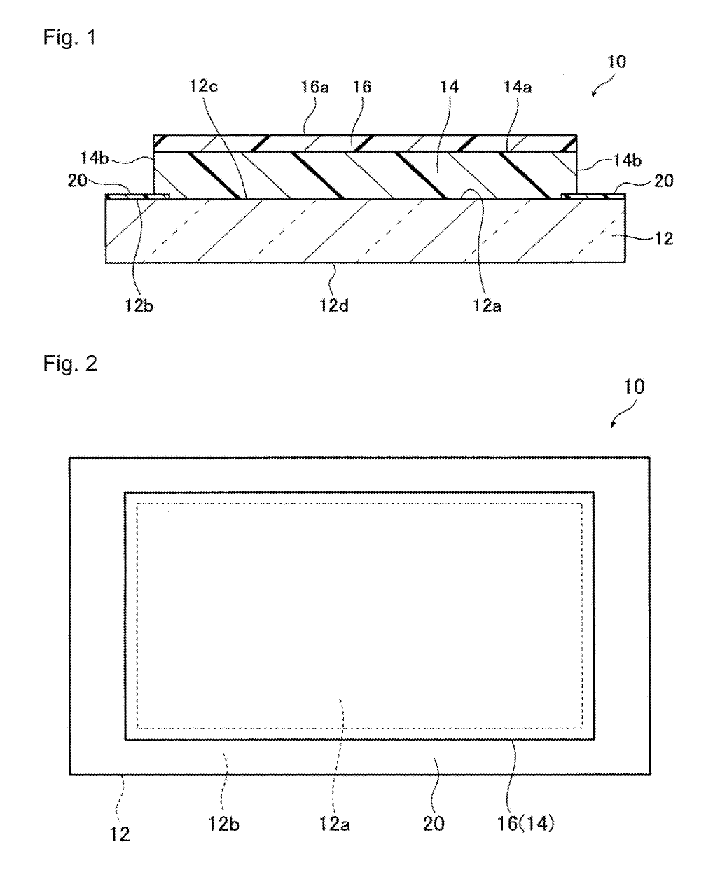

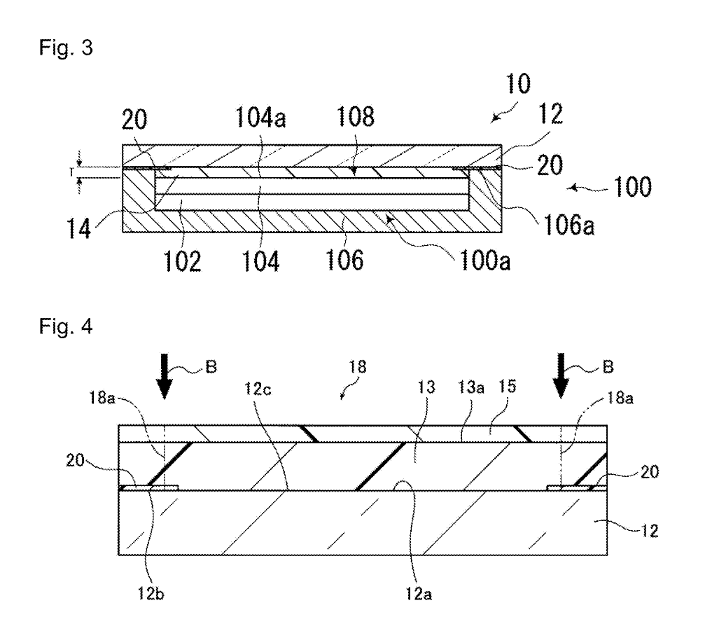

FIG. 1 is a schematic cross-sectional view showing an adhesive layer-equipped transparent plate in one embodiment of the present invention. FIG. 2 is a schematic plan view showing the adhesive layer-equipped transparent plate in one embodiment of the present invention. FIG. 3 is a schematic cross-sectional view showing an in-vehicle display device having the adhesive layer-equipped transparent plate in one embodiment of the present invention bonded.

The adhesive layer-equipped transparent plate 10 shown in FIGS. 1, 2 and 3 is to be bonded to a display panel 104, and it is used to protect the display surface 104a (display area) of the display panel 104. The adhesive layer-equipped transparent plate 10 comprises a transparent plate 12 and an adhesive layer 14, and, in this embodiment, further has a protective film 16 and a light shielding portion 20.

In the adhesive layer-equipped transparent plate 10, the adhesive layer 14 is provided on the transparent plate 12. In the transparent plate 12, the region where the adhesive layer 14 is provided, will be referred to as the disposition region 12a. In the transparent plate 12, a light-shielding portion 20 is formed along the peripheral portion 12b, and on the first main surface 12c of the transparent plate 12, the adhesive layer 14 is formed. The adhesive layer 14 is transparent like the transparent plate 12. In order to suppress multiple reflection, etc. thereby to obtain a good image in the in-vehicle display device having the adhesive layer-equipped transparent plate 10 bonded, it is preferred that the difference in refractive index is small between the transparent pate 12 and the adhesive layer 14.

As shown in FIG. 2, the shapes of the transparent plate 12 and the adhesive layer 14 are, for example, rectangular shapes in plan view, and the adhesion layer 14 is smaller in the outer shape. The adhesive layer 14 is disposed, for example, so that its center matches to the center of the transparent plate 12. In the first main surface 12c of the transparent plate 12, the light shielding portion 20 is formed at the peripheral portion 12b along the peripheral edge of the disposition region 12a.

On the first main surface 14a of the adhesive layer 14, a protective film 16 covering the entire surface of the transparent plate 12 is provided so that it may be peeled off. At the time of bonding the adhesive layer-equipped transparent plate 10 to the display panel 104, the protective film 16 is peeled off. In such a case, for example, a cut is made in the first main surface 16a of the protective film 16, to peel off the protective film 16.

### Transparent Plate (Plate Glass)

The transparent plate 12 is one to protect the display surface 104a (display area) of the display panel 104, and is usually a plate-shaped member (typically a plate glass) with a flat or curved surface.

The plate thickness of the plate glass as the transparent plate 12 is from 0.4 to 3.0 mm. If the plate thickness is less than 0.4 mm, the strength of the transparent plate 12 itself tends to be insufficient, and the impact resistance of the adhesive layer-equipped transparent plate 10 tends to be poor. On the other hand, if the plate thickness exceeds 3.0 mm, the thickness becomes too thick, and such becomes unsuitable for application to an in-vehicle display device from the viewpoint of design. The plate thickness of the transparent plate 12 is more preferably from 0.6 to 3.0 mm, further preferably from 0.6 to 2.0 mm, particularly preferably from 1.3 to 2.0 mm.

The outer shape and size of the transparent plate 12 are generally larger than those of the display panel, from the viewpoint of design, mounting of a sensor and mounting on a display module. From the viewpoint of design, the shape of the transparent plate 12 is suitably determined to meet with the in-vehicle display device 100. The in-vehicle display device 100 may be various in shape, such as rectangular, trapezoidal, etc., and in such a case, the outer shape of the transparent plate 12 is, in many cases, equivalent to the outer shape of the in-vehicle display device 100. Depending upon the outer shape of the in-vehicle display device 100, it is possible to use a transparent plate 12 having a curved shape in the outer shape, to cover the entire surface of the display surface of the display panel.

As an example of the size of the transparent plate 12, for example, in the case of a rectangular one, the longitudinal direction: from 100 to 500 mm, and the lateral direction: from 40 to 300 mm, may be mentioned.

In the case of using a plate glass as the transparent plate 12, for example, tempered glass having tempering treatment applied to colorless and transparent soda-lime glass or aluminosilicate glass (SiO₂—Al₂O₃—Na₂O glass) may be preferably mentioned.

Among them, from the viewpoint of the strength of the plate glass 12 itself, tempered glass (e.g. manufactured by Asahi Glass Company, Limited, “Dragon Trail (registered trademark)”) having tempering treatment applied by ion exchange to aluminosilicate glass, is preferably used.

Here, as the glass material to constitute the plate glass 12, for example, a glass material comprising, as represented by mol %, from 50 to 80% of SiO₂, from 1 to 20% of Al₂O₃, from 6 to 20% of Na₂O, from 0 to 11% of K₂O, from 0 to 15% of MgO, from 0 to 6% of CaO and from 0 to 5% of ZrO₂, may be mentioned.

On both surfaces of tempered glass obtained by subjecting a plate glass 12 to chemical tempering treatment, a compressive stress layer is formed, and the thickness of the compressive stress layer is at least 10 μm, preferably at least 15 μm, more preferably at least 25 μm, further preferably at least 30 μm. The surface compressive stress in the compressive stress layer is preferably at least 650 MPa, more preferably at least 750 MPa.

The method for applying chemical tempering treatment to a plate glass 12 may typically be a method of immersing the plate glass 12 in a KNO₃ molten salt for ion exchange treatment, followed by cooling to about room temperature. The treating conditions such as the temperature of the KNO₃ molten salt and the immersing time may be set so that the surface compressive stress and the thickness of the compressive stress layer will have the desired values.

### Adhesive Layer

The adhesive layer 14 is one to adhere the transparent plate 12 to the display panel 104 at the time of bonding the transparent plate 12 to the display panel 104. The adhesive layer 14 may be formed by coating on the transparent plate 12 by die coating, etc., or may be one cured into a film-form separately from the transparent pate 12. In the following, an adhesive layer 14 provided on a transparent plate 12 will be described.

The adhesive layer 14 has a storage shear modulus at a temperature of 25° C. and at a frequency of 1 Hz (hereinafter, for the sake of convenience, referred to also as “G′ (1 Hz)”) of at most 30 MPa.

Here, G′ (1 Hz) is intended for a storage shear modulus at normal time i.e. not at the time of collision accident. When G′ (1 Hz) is within the above range, the adhesive layer 14 at normal time is relatively soft and the stress is relaxed, and in an in-vehicle display device, an irregularity of the display surface caused by the stress of the adhesive layer 14 is suppressed, and it is excellent in visibility.

In this embodiment, G′ (1 Hz) is at most 30 MPa, and from the reason that the effect for visibility will be better, it is preferably at most 15 MPa, more preferably at most 8 MPa, further preferably at most 4 MPa. Further, in a case where a curable resin composition as described later is to be used in a liquid form, the curing shrinkage is preferably at most 5%.

The lower limit value for G′ (1 Hz) is not particularly limited, but, for example, 0.3 MPa is preferred, and 1 MPa is more preferred.

Further, the adhesive layer 14 has a storage shear modulus at a temperature of 25° C. and at a frequency of 40 kHz (hereinafter, for the sake of convenience, referred to also as “G′ (40 kHz)”) of at least 50 MPa.

Here, G′ (40 kHz) is intended for a storage shear modulus at the time of collision accident. When G′ (40 kHz) is within the above range, the adhesive layer 14 at the time of collision accident, is relatively hard, and the rigidity as a whole of the adhesive layer-equipped transparent plate 10 also becomes high, so that it is possible to obtain such an excellent impact resistance as not to be broken even if hit by the occupant's head, etc.

In this embodiment, from the reason that the effect for impact resistance will be better, G′ (40 kHz) is preferably at least 80 MPa, more preferably at least 100 MPa.

Further, the upper limit value for G′ (40 kHz) is not particularly limited, but, for example, 500 MPa is preferred, and 300 MPa is more preferred.

Further, the loss tangent tanδ being the ratio (G″/G′) of the loss shear modulus at a temperature of 25° C. and at a frequency of 40 kHz, of the adhesive layer 14 (hereinafter, for the sake of convenience, referred to as “G″ (40 kHz)”), to the above-mentioned storage shear modulus “G′ (40 kHz)” at a temperature of 25° C. and at a frequency of 40 kHz, of the adhesive layer 14, is, from the reason for excellent impact resistance, at least 0.1, and from the reason that the effect for impact resistance will be better, preferably at least 0.2 and more preferably at least 1.0.

Here, G′ (1 Hz) of the adhesive layer 14 is measured by using a rheometer (manufactured by Anton paar Co., Ltd., modular rheometer Physica MCR 301). G′ (40 kHz) and G″ (40 kHz) are obtained by measuring frequency distributed data at various temperatures by TA Instruments Inc. AresG2 rheometer, and preparing a master curve by accessory analysis software Trios.

Further, the adhesive layer 14 preferably has an interfacial peel strength at a tensile speed of 4 m/s of at least 600 N/225 mm². The effect for impact resistance will thereby be better.

Here, the tensile speed of “4 m/s” is intended for the collision speed at the time when a rigid model is impinged at a high speed in the head impact test as described hereinafter.

When the interfacial peel strength measured at such a tensile speed, is within the above range, even at the time of collision accident, the transparent plate 12 and the adhesive layer 14 are less likely to be peeled, the rigidity as a whole of the adhesive layer-equipped transparent plate 10 will be maintained, and it is possible to obtain such an excellent impact resistance as not to be broken even when hit by the occupant's head, etc.

In this embodiment, from the reason that the effect for impact resistance will be better, the above interfacial peel strength is more preferably at least 700 N/225 mm², further preferably at least 850 N/225 mm².

On the other hand, the upper limit value is not particularly limited, but it is, for example, 2,000 N/225 mm², preferably 1,500 N/225 mm².

Here, the interfacial peel strength in this embodiment is obtained by a tensile test wherein, although details will be described in EXAMPLES given later, schematically, first, by using glass as the transparent plate 12, via the adhesive layer 14, glass pieces are bonded together so that the bonding surface will be a square of 15 mm×15 mm (bonding area: 225 mm²) and then, one of the glass pieces is pulled up at an tensile speed of 4 m/s in a direction perpendicular to the other glass piece.

The thickness of the adhesive layer 14 may present an adverse effect on the visibility if too thick, and, if too thin, the impact resistance may not be fully exhibited, and therefore, it is preferably from 30 to 2,000 μm, more preferably from 50 to 1,000 μm, further preferably from 100 to 500 μm.

The adhesive layer 14 is, for example, a layer (resin layer) made of a transparent resin obtained by curing a liquid-form curable resin composition.

### Curable Resin Composition

As the curable resin composition, a thermosetting resin composition and a photocurable resin composition may be mentioned, and a photocurable resin composition is preferred.

As the photocurable resin composition, from the viewpoint of the curing rate and transparency of the resin layer, a photocurable resin composition comprising at least one type of compound (hereinafter referred to as a (meth)arylate compound) having at least one group (hereinafter referred to as a (meth)acryloyloxy group) selected from the group consisting of an acryloyloxy group and a methacryloyloxy group, is preferred.

In a (meth)acrylate compound, the number of (meth)acryloyloxy groups per 1 molecule is preferably from 1 to 6, and, from the reason that the resin layer will not be too hard, more preferably from 1 to 4, further preferably from 1 to 3.

Further, as the (meth)acrylate compound, from the viewpoint of light resistance of the resin layer, a compound that does not contain an aromatic ring as far as possible, is preferred.

Still further, as the (meth)acrylate compound, from the viewpoint of improving the interfacial adhesion, a compound having a hydroxyl group (hydroxy group) is more preferred.

The (meth)acrylate compound may be a relatively low molecular weight compound (hereinafter referred to as an acrylate monomer) or a relatively high molecular weight compound having repeating units (hereinafter referred to as a (meth)acrylate oligomer).

The (meth)acrylate compound may, for example, be one composed of at least one (meth)acrylate monomer, one composed of at least one (meth)acrylate oligomer, or one composed of at least one (meth)acrylate monomer and at least one (meth)acrylate oligomer.

Among them, one composed of at least one (meth)acrylate oligomer, or one composed of at least one (meth)acrylate oligomer and at least one (meth)acrylate monomer, is preferred, and one composed of at least one (meth)acrylate oligomer and at least one (meth)acrylate monomer, is more preferred.

The (meth)acrylate oligomer may, for example, be a urethane (meth)acrylate oligomer having from 1.8 to 4 (meth)acryloyloxy groups per molecule on average.

Such a urethane (meth)acrylate oligomer may, for example, be one obtainable by reacting a hydroxyalkyl (meth)acrylate as described below, to a urethane prepolymer obtained by reacting a polyol (e.g. a modified or unmodified polypropylene glycol) with a polyisocyanate (e.g. isophorone diisocyanate) in such a ratio that hydroxyl groups:isocyanate groups=1:1.1 to 1.5.

The molecular weight of the urethane (meth)acrylate oligomer is preferably from 1,000 to 60,000, more preferably from 1,000 to 40,000, further preferably from 15,000 to 35,000.

Here, the molecular weight is meant for the number average molecular weight and is a value measured by a gel permeation chromatography method using polystyrene as a standard substance (the same applies hereinafter).

On the other hand, the (meth)acrylate monomer may, for example, be a hydroxyalkyl (meth)acrylate having a C₃₋₈ (preferably C₃₋₆) hydroxyalkyl group having one or two hydroxyl groups, and specific examples thereof include 2-hydroxypropyl (meth)acrylate, 2-hydroxybutyl (meth)acrylate, 4-hydroxybutyl (meth)acrylate, etc.

Further, as the (meth)acrylate monomer, for example, an alkyl (meth)acrylate having a C₆₋₂₂ alkyl group may also be preferably mentioned. Here, the C₆₋₂₂ (preferably C₆₋₁₈, more preferably C₇₋₁₄) alkyl group may be an alicyclic alkyl group, but a straight chain alkyl group is preferred. Specific examples of such an alkyl (meth)acrylate include n-dodecyl (meth)acrylate, n-octadecyl (meth)acrylate, n-behenyl (meth)acrylate, etc.

Here, as the (meth)acrylate monomer, it is preferred to use the aforementioned hydroxyalkyl (meth)acrylate and the aforementioned alkyl (meth)acrylate in combination, and it is preferred that the content of the alkyl (meth)acrylate is larger than the content of the hydroxyalkyl (meth)acrylate.

Further, in 100 mass % of the (meth)acrylate compound, the content of the urethane (meth)acrylate oligomer is preferably from 20 to 60 mass %, more preferably from 35 to 50 mass %. Further, the content of the (meth)acrylate monomer is preferably from 40 to 80 mass %, more preferably from 50 to 65 mass %.

The photocurable resin composition preferably contains a photopolymerization initiator in addition to the above-mentioned (meth)acrylate. The photopolymerization initiator is not particularly limited, and a conventional photopolymerization initiator may be used, and its content is also not particularly limited and, for example, is from 0.1 to 2.5 parts by mass, preferably from 0.3 to 1.2 parts by mass, to 100 parts by mass of the (meth)acrylate compound.

In addition, known additives such as a polymerization inhibitor, a chain transfer agent, etc. may suitably be incorporated, as the case requires.

### Protective Film

A protective film 16 may be used to protect the adhesive layer 14. It is, of course, unnecessary in a case where the transparent plate 12, the adhesive layer 14 and the display panel module 100a (see FIG. 3) are laminated at once.

The protective film 16 is required to be peeled from the adhesive layer 14 and required that in the production method as described later, the adhesive layer 14 of the adhesive layer-equipped transparent plate 10 can be bonded to a support surface member (not shown). Thus, as the protective film 16, the surface in contact with the adhesive layer 14 is preferably a relatively low adhesive substrate film made of polyethylene, polypropylene or a fluorinated resin. The surface in contact with the support surface member of the protective film 16 is preferably made to be an adhesive surface, and the adhesive surface is preferably made of a self-adhesive layer formed on the substrate film.

The thickness of the protective film 16 is, when a relatively flexible film such as polyethylene or polypropylene is used, preferably from 0.03 to 0.2 mm, more preferably from 0.05 to 0.1 mm.

### Light Shielding Portion

A light shielding portion 20 is one to shield a wiring member, etc. connected to the display panel 104, other than the display surface 104a (display area) of the display panel 104 as described later, so as not to be seen from the second main surface 12d side of the transparent plate 12. The light shielding portion 20 is formed in a frame shape. Further, the light shielding portion 20 can be formed on either the first main surface 12c or the second main surface 12d of the transparent plate 12 by using organic printing or ceramic printing. With a view to reducing the parallax between the light shielding portion 20 and the display region, it is preferably formed on the first main surface 12c of the transparent plate 12. In a case where the transparent plate 12 is a glass plate, it is preferred to form the light shielding portion 20 by applying a ceramic paint composition containing a black pigment by a ceramic printing method, whereby the light shielding property will be high.

The light-shielding portion 20 may not necessarily be provided on the transparent plate 12, for example, in a case where the wiring member, etc. of the display panel will not be seen from the side of watching the display panel, or in a case where shielded by the frame of the in-vehicle display device or by another member such as a housing, etc., or in a case where the adhesive layer-equipped transparent plate is bonded to an object to be bonded other than a display panel.

In the adhesive layer-equipped transparent plate 10, the area (disposition area 12a) surrounded by the light-shielding portion 20 becomes a light transmitting portion.

### Method for Producing Adhesive Layer-Equipped Transparent Plate

The method for producing an adhesive layer-equipped transparent plate 10 will be described. In the following, an embodiment will be described in which a liquid resin composition is applied on a transparent plate 12, followed by curing it.

FIG. 4 is a schematic cross-sectional view illustrating a method for producing an adhesive layer-equipped transparent plate in one embodiment of the present invention.

First, along the peripheral edge portion 12b of the transparent plate 12, a light shielding portion 20 is formed in a frame shape (see FIG. 2). Then, a curable resin composition is applied over the entire first main surface 12c of the transparent plate 12 to cover the light shielding portion 20 by using, for example, a method such as a die coater, a roll coater, etc., to form a curable resin composition film 13. The curable resin composition film 13 will be cut as described below and becomes an adhesive layer 14.

Then, on the surface 13a of the curable resin composition film 13, a film material 15 is bonded. The film material 15 will be cut as described below and becomes a protective film 16. After bonding the film material 15 on the surface 13a of the curable resin composition film 13, the curable resin composition film 13 is cured by thermal curing or photo-curing treatment, to obtain a laminate 18 having the curable resin composition film 13 protected by the film material 15.

In a case where the curable resin composition film 13 is made of a photocurable composition, it will be cured, for example, by irradiation with ultraviolet light or short-wavelength visible light with a wavelength of at most 450 nm by using a light source such as an ultraviolet lamp, a high pressure mercury lamp or UV-LED.

Then, in the laminate 18, the position which becomes to be the side surface 14b of the adhesive layer 14 is set to be a cutting line 18a. Using a laser beam B, the laminate 18 is cut along the cutting line 18a. Thus, an adhesive layer-equipped transparent plate 10 provided with a protective film 16 on the first main surface 14a of the adhesive layer 14 is obtainable. Here, as the laser beam B, for example, CO₂ laser is used. Here, the cutting step may be omitted, for example, in a case where a pre-cured adhesive layer film is bonded on the transparent plate 10, or in a case where the resin composition can be precisely coated.

### In-Vehicle Display Device

Now, a case where an in-vehicle display device 100 is formed by bonding the adhesive layer-equipped transparent plate 10 to a display panel module 100a, will be described in detail.

FIG. 3 is a schematic cross-sectional view showing an in-vehicle display device 100 having the adhesive layer-equipped transparent plate bonded in one embodiment of the present invention.

As shown in FIG. 3, in the in-vehicle display device 100, a display panel 104 is mounted on a backlight unit 102, and these backlight unit 102 and display panel 104 are housed in a metal frame 106. This frame 106 has an opening 108, and the display panel 104 is disposed on the opening 108 side. The area corresponding to the opening 108 of the display panel 104 is designated as a display surface 104a. A display panel module 100a is constituted by the backlight 102 and the display panel 104 as the main components.

The constructions of the backlight unit 102 and the display panel 104 are not particularly limited, and known constructions may be used.

As shown in FIG. 3, in the opening 108 of the frame 106, there is a step from the display surface 104a of the display panel 104 to the end surface 106a of the frame 106, and the length of the step is T. The distance T of this step is, for example, from about 0.8 to 2.3 mm.

As shown in FIG. 3, of the adhesive layer-equipped transparent plate 10, the adhesive layer 14 is bonded on the display surface 104a of the display panel 104 so as to fill the opening 108 of the frame 106. Thus, from the display surface 104a of the display panel 104 to the end surface 106a of the frame 106 is covered by the transparent plate 12. This transparent plate 12 functions as a protective member for the display surface 104a of the display panel 104.

Here, the adhesive layer-equipped transparent plate 10 is bonded by peeling the protective film 16. An object to which the adhesive layer-equipped transparent plate 10 is to be bonded, may be a finished product such as an in-vehicle display device 100, or a semi-finished product such as a display panel module 100a so-called a LCD module, and thus, includes any finished product and semi-finished product, without any particular limitation. The in-vehicle display device 100 may, for example, be one having an organic EL panel, PDP or an electronic ink-type panel. Further, it may also be used as bonded to a coordinate input device such as a touch panel.

Such an in-vehicle display device 100 may, for example, be an on-dash type car navigation system erected on a dashboard, or an in-dash type car navigation device embedded in a dashboard of a vehicle, or it may further be a device other than a car navigation device (e.g. an instrument panel).

### EXAMPLES

Now, the present invention will be described in detail with reference to Examples, but the present invention is by no means limited by these Examples.

### Preparation of Plate Glass

As a plate glass being a transparent plate, tempered glass (manufactured by Asahi Glass Company, Limited, “Dragon Trail” (registered trademark), thickness: 0.7 mm, vertical: 150 mm, width: 250 mm, thickness of compressive stress layer: 35 μm, surface compressive stress in compressive stress layer: 750 MPa) having chemical tempering treatment applied to aluminosilicate glass, was prepared.

### Preparation of Adhesive Layer

The following adhesive layers 1 to 4 were prepared.

Adhesive layer 1: One obtained by curing a curable resin composition prepared as shown below

Adhesive layer 2: One obtained by curing a curable resin composition prepared as shown below

Adhesive layer 3: Manufactured by NICHIEI KAKOH CO., LTD “MHM-FWD175”

Adhesive layer 4: One obtained by curing a curable resin composition prepared as shown below

Each adhesive layer was made to have a size of thickness: 175 μm, vertical: 120 mm, and horizontal: 173 mm. Here, each adhesive layer had, in the case of a thickness of 175 μm, a visible light luminous average transmittance of at least 50%.

### Preparation of Adhesive Layer 1

Difunctional polypropylene glycol having molecular terminals modified with ethylene oxide, and isophorone diisocyanate, were mixed in a molar ratio of 4:5, and reacted at 70° C. in the presence of a tin catalyst, to obtain a prepolymer. To the obtained prepolymer, 2-hydroxyethyl acrylate was added in a molar ratio of 1:2 and reacted at 70° C. to obtain a urethane acrylate oligomer (A) (hereinafter referred to as “oligomer (A)”). The number of acryloyloxy groups in oligomer (A) was two, and the number-average molecular weight of oligomer (A) was about 24,000.

14 Parts by mass of oligomer (A), 7 parts by mass of 2-hydroxybutyl methacrylate (manufactured by Kyoeisha Chemical Co., Ltd., LIGHT ESTER HOB), 7 parts by mass of 4-hydroxybutyl acrylate (manufactured by Osaka Organic Chemical Industry Ltd., 4-HBA), 7 parts by mass of n-dodecyl methacrylate (manufactured by Osaka Organic Chemical Industry Ltd., LA), and 65 parts by weight of a non-curable oligomer obtained by mixing a difunctional polypropylene glycol (number average molecular weight calculated from its hydroxyl value: 4,000) having molecular terminals modified with ethylene oxide and a trifunctional polypropylene glycol (number average molecular weight calculated from its hydroxyl value: 6,200) having molecular terminals modified with ethylene oxide, in a mass ratio of 1:1, were uniformly mixed, to obtain 100 parts by mass of a resin mixture.

To 100 parts by mass of the resin mixture, 0.5 part by mass of bis(2,4,6-trimethylbenzoyl)-phenyl phosphine oxide (photopolymerization initiator, manufactured by Ciba Specialty Chemicals, IRGACURE 819), 0.04 part by mass of 2,5-di-tert-butyl hydroquinone (polymerization inhibitor, manufactured by Tokyo Chemical Industry Co., Ltd.) and 0.1 part by mass of n-dodecyl mercaptan (chain transfer agent, manufactured by Kao Corporation, THIOKALCOL 20), were uniformly dissolved, to obtain a photocurable resin composition 1, and it was cured by UV irradiation to obtain an adhesive layer 1.

### Preparation of Adhesive Layer 2

Difunctional polypropylene glycol and isophorone diisocyanate were mixed in a molar ratio of 4:5, and reacted at 70° C. in the presence of a tin catalyst, to obtain a prepolymer. To the obtained prepolymer, 2-hydroxyethyl acrylate was added in a molar ratio of 1:2 and reacted at 70° C. to obtain a urethane acrylate oligomer (B) (hereinafter referred to as “oligomer (B)”). The number of acryloyloxy groups in oligomer (B) was two, and the number-average molecular weight of oligomer (B) was about 2,000.

30 Parts by mass of oligomer (B), 20 parts by mass of 2-hydroxybutyl methacrylate (manufactured by Kyoeisha Chemical Co., Ltd., LIGHT ESTER HOB), and 50 parts by mass of isobornyl methacrylate (manufactured by Kyoeisha Chemical Co., Ltd., LIGHT ESTER IB-X), were uniformly mixed to obtain 100 parts by mass of a resin mixture.

To 100 parts by mass of the resin mixture, 0.5 part by mass of bis(2,4,6-trimethylbenzoyl)-phenyl phosphine oxide (photopolymerization initiator, manufactured by Ciba Specialty Chemicals, IRGACURE 819), and 0.04 part by mass of 2,5-di-tert-butyl hydroquinone (polymerization inhibitor, manufactured by Tokyo Chemical Industry Co., Ltd.), were uniformly dissolved, to obtain a photocurable resin composition 2, and it was cured by UV irradiation to obtain an adhesive layer 2.

### Preparation of Adhesive Layer

40 Parts by mass of oligomer (A), 20 parts by mass of 2-hydroxybutyl methacrylate (manufactured by Kyoeisha Chemical Co., Ltd., LIGHT ESTER HOB), and 40 parts by mass of n-dodecyl methacrylate (manufactured by Osaka Organic Chemical Industry Ltd., LA), were uniformly mixed to obtain 100 parts by mass of a resin mixture.

To 100 parts by mass of the resin mixture, 0.5 part by mass of bis(2,4,6-trimethylbenzoyl)-phenyl phosphine oxide (photopolymerization initiator, manufactured by Ciba Specialty Chemicals, IRGACURE 819), 0.04 part by mass of 2,5-di-tert-butyl hydroquinone (polymerization inhibitor, manufactured by Tokyo Chemical Industry Co., Ltd.), and 0.1 part by mass of n-dodecyl mercaptan (chain transfer agent, manufactured by Kao Corporation, THIOKALCOL 20), were uniformly dissolved, to obtain a photocurable resin composition 4, and it was cured by UV irradiation to obtain an adhesive layer 4.

### Preparation of Adhesive Layer-Equipped Transparent Plate

On the first main surface of a plate glass, each of the adhesive layers 1 to 4 was laminated, to prepare each of the adhesive layer-equipped transparent plates in Ex. 1 to 4. The adhesive layer was disposed so that the center matched against the center of the plate glass. Further, the thickness of the adhesive layer was 175 μm in each case.

### Modulus of Elasticity of Adhesive Layer

With respect to each of the adhesive layers 1 to 4, the storage shear modulus (G′ (1 Hz)) at a temperature of 25° C. and at a frequency of 1 Hz, the storage shear modulus (G′ (40 kHz)) at a temperature of 25° C. and at a frequency of 40 kHz, and the loss shear modulus (G″ (40 kHz)) at a temperature of 25° C. and at a frequency of 40 kHz, were measured.

Further, from the values of the measured G′ (40 kHz) and G″ (40 kHz), the loss tangent (tanδ) was also calculated. The results are shown in the following Table 1.

### Interfacial Peel Strength

For example, with respect to an adhesive tape, etc., in general, in a case where the sample is thin and the peeling is high, as a failure mode, interfacial peeling tends to be dominant. Therefore, with respect to each of the adhesive layers 1 to 4 having the thickness adjusted to be 175 μm, a tensile test was conducted at a tensile speed of 4 m/s, to obtain the interfacial peel strength. In the tensile test, a 350 kN servohydraulic high speed tensile testing machine (model number: V-0656) manufactured by Saginomiya Seisakusho Inc. was used, whereby the maximum tensile speed was 12 m/s.

Here, the tensile speed of 4 m/s was set in conscious of a collision speed (3.9 m/s) at the time when a rigid model is impinged at a high speed in the head impact test as described below.

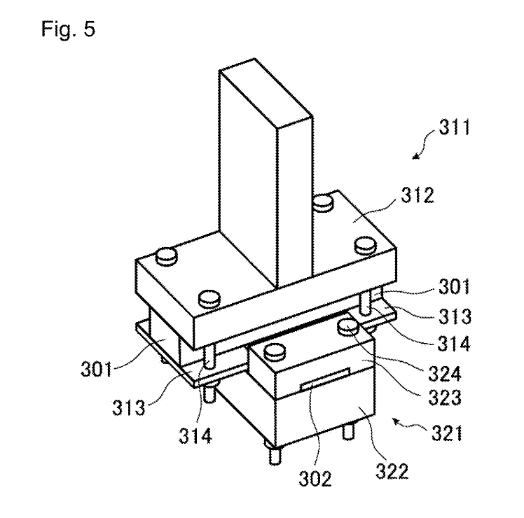

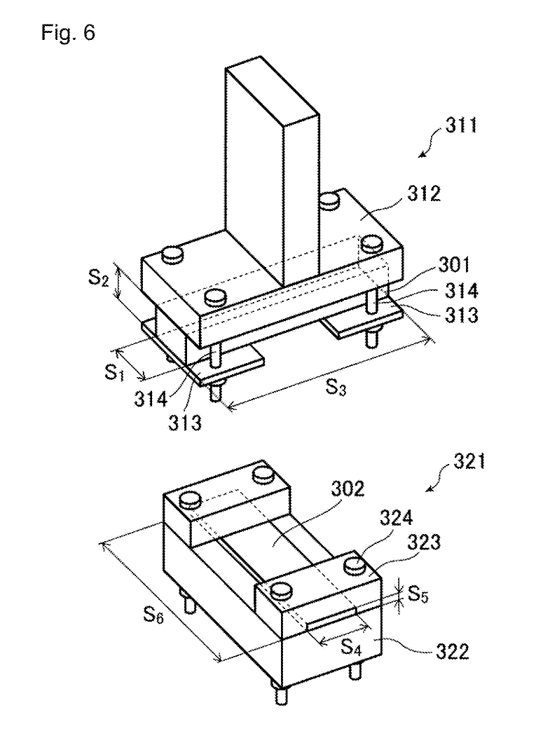

In the following, the tensile test will be described in more detail, based on FIGS. 5 and 6.

FIG. 5 is a perspective view schematically showing a state before peeling by the tensile test, and FIG. 6 is a perspective view schematically showing a state after peeling by the tensile test. In FIGS. 5 and 6, illustration of the adhesive layer is omitted.

In the specific procedure, first, an upper glass piece 301 of square pillar shape (S₁: 15 mm, S₂: 10 mm, S₃: 60 mm) made of soda lime glass to be used as a display panel substitute to be described later, and a lower glass piece 302 of thin plate shape (S₄: 15 mm, S₅: 2 mm, S₆: 60 mm) made of the above-mentioned plate glass (manufactured by Asahi Glass Company, Limited, “Dragon Trail” (registered trademark)), were prepared. Here, to the above-mentioned plate glass used for the lower glass piece 302, chemically tempering treatment was applied for the purpose of preventing breakage at the time of high speed pulling.

Then, the upper glass piece 301 and the lower glass piece 302 were, after subjected to ultrasonic cleaning, disposed crosswise to let the respective surfaces of 15 mm wide face each other via each of adhesive layers 1 to 4, so that the adhesive surface became a square of 15 mm (S₁)×15 mm (S₄) (adhesion area: 225 mm²). At that time, with respect to the adhesive layers 1, 2 and 4, each of photocurable resin compositions 1, 2 and 4 was applied to an adhesive surface, then the upper glass piece 301 and the lower glass piece 302 were put together, and thereafter, the adhesive surface was irradiated and cured by UV radiation through the lower glass piece 302. Each of adhesive layers 1 to 4 was adjusted to have a thickness of 175 μm.

Then, the upper glass piece 301 and the lower glass piece 302 bonded via the adhesive layer, were respectively held by an upper retainer 311 and a lower retainer 321 (see FIG. 5). The upper retainer 311 was constituted mainly by a T-shaped member 312, and on the main surface of this T-shaped member 312, the upper glass piece 301 was held by using holding plates 313 and screws 314. Whereas, the lower retainer 321 was constituted mainly by a plank member 322 of rectangular parallelepiped, and on the main surface of the plank member 322, the lower glass piece 302 was held by using clamping members 323 and screws 324. Here, the clamping members 323 were members wherein a cutout corresponding to the thickness of the lower glass piece 302 was formed. The T-shaped member 312, the holding plates 313, the plank member 322 and the clamping members 323, are, respectively, made of steel.

Then, the lower retainer 321 holding the lower glass piece 302 was fixed in position, and a high-speed tensile test of pulling up the upper retainer 311 holding the upper glass piece 301, instantaneously at a speed of 4 m/s in a direction perpendicular to the lower glass piece 302, was carried out to peel the upper glass piece 301 from the lower glass piece 302. By this test, the interfacial peel strength of each of the adhesive layers 1 to 4 was obtained. The results of this interfacial peel strength are shown in the following Table 1.

In the above test, the upper glass piece was made of soda-lime glass, but it may be the same glass as the lower glass piece (the above-mentioned plate glass (manufactured by Asahi Glass Company, Limited, “Dragon Trail” (registered trademark))), and tempered glass having chemical tempering treatment applied), and it has been confirmed that even in such a case an equivalent interfacial peel strength is obtainable.

### Evaluation of Impact Resistance

### Preparation of Test Specimen

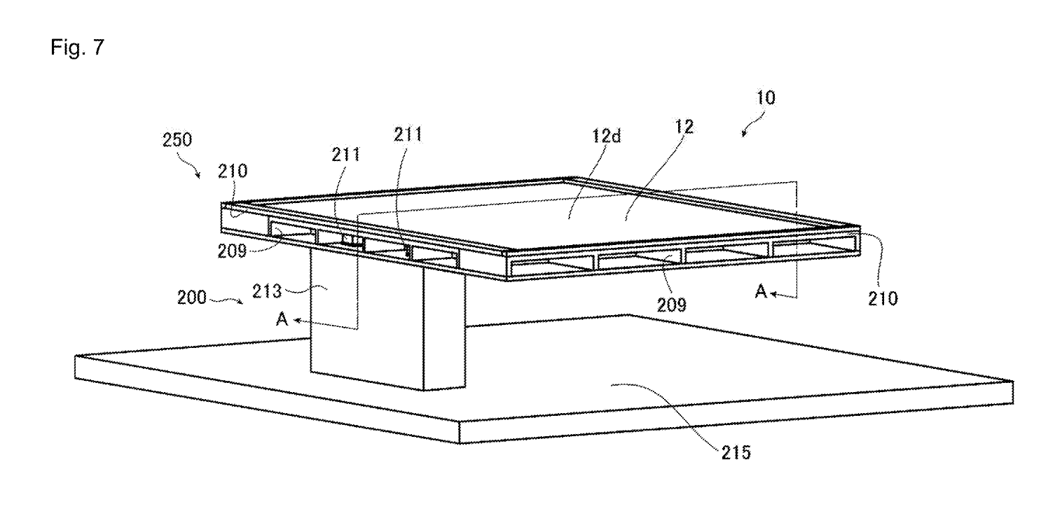

First, in order to carry out a test of impinging a rigid model (referred to also as a “head impact test”), a test specimen 200 was prepared. The test specimen 200 will be described with reference to FIGS. 7 to 9.

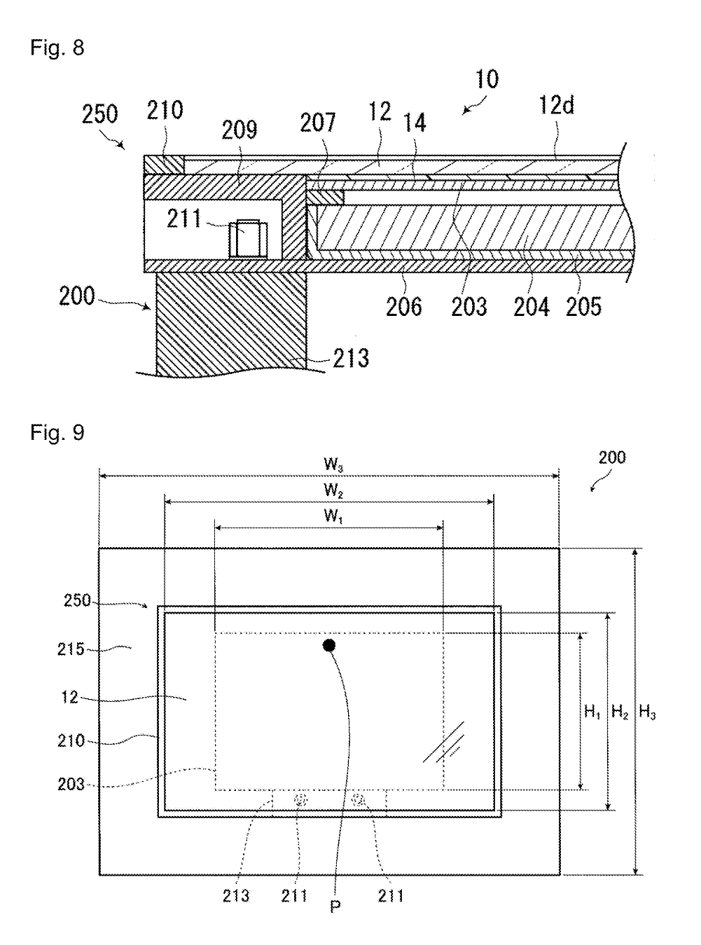

FIG. 7 is a perspective view showing the test specimen. FIG. 8 is a cross-sectional view along line A-A in FIG. 7. FIG. 9 is a plan view showing the test specimen.

The test specimen 200 is simulating an in-vehicle display device 100 of on-dash type, which is constituted mainly by a housing 250 simulating a display panel module.

The housing 250 has a housing bottom member 206 being a thin plate, and on the periphery of the housing bottom member 206, four housing frames 209 provided with ribs inside are disposed. By the four housing frames 209, at the central region of the housing bottom member 206, a rectangular recess is formed, and in this recess, a backlight unit substitute 204 simulating a backlight unit, and a display panel substitute 203 simulating a display panel, are disposed. Of the backlight unit substitute 204, its sides and bottom are covered by an aluminum die-casting 205.

The end portion on the upper surface side of the backlight unit substitute 204 is bonded to the end portion on the lower surface side of the display panel substitute 203 by e.g. a double-sided tape 207. Thus, between the display panel substitute 203 and the backlight unit substitute 204, an air gap corresponding to the thickness of the double-sided tape 207, is present. The space created by this air gap is set to be from 0.5 to 1.5 mm from the backlight unit 102 to the display panel. Usually the air gap is set to be 1.5 mm, but it may not be 1.5 mm depending upon the circumstance, and there may be no air gap. The air gap is controlled by the thickness of the adhesive member such as a double-sided tape 207, and may not be used depending on the situation. The upper surface of the display panel substitute 203 is at a lower position than the upper surface of the housing frame 209 disposed around the circumference, and has a recess. So as to fill the recess, the adhesive layer 14 of the adhesive layer-equipped transparent plate 10 is bonded on the upper surface of the display panel substitute 203. Outside of the side end surface of the plate glass 12 being the transparent plate and on the upper surface of the housing frame 209, a housing end frame 210 is disposed.

Such a housing 250 is fixed to a solid fixing rib 213 integral with a support plate 215 being a flat plate, by a bolt 211 disposed in a space in one housing frame 209.

Here, in the test specimen 200 thus prepared, materials, sizes, etc. of the respective members were as follows.

Plate glass 12 . . . plate thickness: 0.7 mm, vertical: 150 mm (H₂ in FIG. 9), horizontal: 250 mm (W₂ in FIG. 9).

Adhesive layer 14 . . . thickness: 175 μm, vertical: 120 mm (H₁ in FIG. 9), horizontal: 173 mm (W₁ in FIG. 9).

Display panel substitute 203 . . . one having a polarizing plate (glue 20 μm/TAC 40 μm/PVA 20 μm/CAT 20 μm) bonded on both sides of soda lime glass (thickness 1.1 mm), thickness: 1.3 mm, vertical: 120 mm (H₁ in FIG. 9), horizontal: 173 mm (W₁ in FIG. 9).

Backlight unit substitute 204 . . . material: polycarbonate, thickness: 4 mm, vertical: 117 mm, horizontal: 170 mm.

Aluminum die-cast 205 . . . thickness: 1 mm, vertical: 118 mm, horizontal: 178 mm, height: 5 mm.

Housing bottom member 206 . . . material: ABS, thickness: 1 mm, vertical: 160 mm, horizontal: 260 mm.

Double-sided tape 207 . . . manufactured by Sumitomo 3M Ltd., “Scotch PBT-10”, tape width: 5 mm, tape thickness: 0.5 mm.

Housing frame 209 . . . material: ABS, thickness: 1 mm.

Housing end frame 210 . . . material: ABS, thickness: 2 mm, width: 5 mm.

Bolt 211 . . . material: iron.

Fixing rib 213 . . . material: iron, size: 19 mm×100 mm×50 mm.

Support plate 215 . . . material: iron, plate thickness: 9 mm, vertical: 250 mm (H₃ in FIG. 9), horizontal: 350 mm (W₃ in FIG. 9).

Further, at the time of the head impact test which will be described later, an iron plate (vertical: 114 mm, horizontal: 214 mm) was bonded to the bottom surface (the surface on the support plate 215 side) of the housing bottom member 206. This iron plate was set closer to the end on the side opposite to the fixing rib 213 side and bonded so that the center in the horizontal direction was aligned with the housing bottom surface 206.

Further, between the housing 250 and the support plate 215, a shock-absorbing cushion (manufactured by K.C.C. SHOKAI LIMITED, “CF45”, thickness: 25.4 mm) was sandwiched at two stages.

### Head Impact Test

Then, the support plate 215 of the test specimen 200 was placed on a horizontal surface, and at the collision position P (see FIG. 9) on the second main surface 12d of the plate glass 12, a spherical rigid model (not shown) (material: iron, diameter: 165 mm, mass: 19.6 kg) was dropped from a height of 794 mm and collided at a collision speed of 3.9 m/s, so that the energy at the time of collision would be 152.5 J.

For the test method, reference was made to “Exhibit 28: Technical standards for shock absorption of instrument panel” in “Article 20: Riding equipment” of “Safety standards for road transport vehicle” indicated by the Ministry of Land, Infrastructure and Transport (hereinafter referred to simply as “standards”). In this “standards”, it is stipulated that a spherical rigid model (material: iron, diameter: 165 mm, mass: 6.8 kg) is injected and collided at a collision speed of 6.7 m/s, so that the energy at the time of collision would be 152.4 J.

That is, in the head impact test using the test specimen 200, the energy at the time of collision was adjusted to be equal to the “standards”.

The collision position P (see FIG. 9) on the plate glass 12, at which the rigid model is to be impinged, was set to be at a position closer to the side opposite to the fixing rib 213 side from the center of the housing 250, as the test specimen 200 is viewed from the upper surface. More particularly, the collision position P is not on the housing frame 209, but on the display panel substitute 203, and at a position inside by 10 mm from the edge of the display panel substitute 203.

The results obtained by colliding the rigid model were evaluated by the following standards. If “A”, it can be evaluated as one showing such an excellent impact resistance that it would not be broken even if hit by the driver's head at the time of collision accident.

“A” . . . The plate glass was not broken.

“B” . . . The plate glass was broken.

The results of this impact resistance are shown in the following Table 1.

### Evaluation of Visibility

The adhesive layer of an adhesive layer-equipped transparent plate was bonded to a display surface of a commercially available liquid crystal panel, and by lighting the backlight unit, the display surface was observed from three different directions (from the front, the right oblique front and the left oblique front, to the screen) to evaluate the display failure by the following standards. If “A”, it can be evaluated as one being excellent in visibility.

“A” . . . No irregularity was observed on the display surface.

“B” . . . Irregularities were observed on the display surface.

The results of this visibility are shown in the following Table 1.

TABLE 1

| | Adhesive layer | | | | | | | | |
|---|---|---|---|---|---|---|---|---|---|
| | Employed | | | | | Interfacial peel | Evaluation | | |
| | adhesive | Thickness | G′ (1 Hz) | G′ (40 kHz) | tanδ | strength | Impact | | |
| | layer | [μm] | [MPa] | [MPa] | (40 kHz) | [N/225 mm²] | resistance | Visibility | Note |
| Ex. 1 | Adhesive | 175 | 0.002 | 0.15 | 0.4 | 508 | B | A | Comparative |
| | layer 1 | | | | | | | | Example |
| Ex. 2 | Adhesive | 175 | 770 | 1,200 | 0.04 | 85 | B | B | Comparative |
| | layer 2 | | | | | | | | Example |
| Ex. 3 | Adhesive | 175 | 0.008 | 6 | 1.2 | 946 | B | A | Comparative |
| | layer 3 | | | | | | | | Example |
| Ex. 4 | Adhesive | 175 | 3.9 | 120 | 0.2 | 928 | A | A | Working |
| | layer 4 | | | | | | | | Example |

As apparent from the results shown in Table 1, in Ex. 1 wherein G′ (40 kHz) was less than 50 MPa, the impact resistance was poor.

Further, in Ex. 2 wherein tanδ was less than 0.1, the impact resistance was poor. Furthermore, in Ex. 2 wherein G′ (1 Hz) exceeded 30 MPa, the display failure occurred, and the visibility was also poor.

Further, in Ex. 3 wherein G′ (40 kHz) was less than 50 MPa, the impact resistance was poor.

Whereas, in Ex. 4 wherein G′ (40 kHz) was at least 50 MPa, and tanδ was at least 0.1, the impact resistance was excellent. Further, in Ex. 4 wherein the interfacial peel strength was at least 600 N/225 mm². Further, in Ex. 4 wherein G′ (1 Hz) was at most 30 MPa, visibility was also good. That is, in Ex. 4, both the impact resistance and visibility were excellent.

### INDUSTRIAL APPLICABILITY

According to the present invention, it is possible to provide an adhesive layer-equipped transparent plate and an adhesive layer, which satisfy both visibility and impact resistance, and they are useful particularly for a cover glass to be bonded in order to protect the display surface side of an in-vehicle display device.

This application is a continuation of PCT Application No. PCT/JP2015/075106, filed on Sep. 3, 2015, which is based upon and claims the benefit of priority from Japanese Patent Application No. 2014-180986 filed on Sep. 5, 2014. The contents of those applications are incorporated herein by reference in their entireties.

### REFERENCE SYMBOLS

10: Adhesive layer-equipped transparent plate, 12: transparent plate (plate glass), 12a: disposition region, 12b: peripheral portion, 12c: first main surface of transparent plate, 12d: second main surface of transparent plate, 13: curable resin composition film, 14: adhesive layer, 14a: first main surface of adhesive layer, 14b: side surface of adhesive layer, 16: protective film, 16a: first main surface of protective film, 18: laminate, 20: light-shielding portion, 100: in-vehicle display device, 100a: display panel module, 102: backlight unit, 104: display panel, 104a: display surface, 106: frame, 106a: end surface, 108: opening, 200: test specimen, 203: display panel substitute, 204: backlight unit substitute, 205: aluminum die-cast, 206: housing bottom member, 207: double-sided tape, 209: housing frame, 210: housing end frame, 211: bolt, 213: fixing rib, 215: support plate, 250: housing, 301: upper glass piece, 302: lower glass piece, 311: upper retainer, 312: T-shaped member, 313: holding plate, 314: screw, 321: lower retainer, 322: plank member, 323: clamping member, 324: screw, P: collision position.

What is claimed is:

1. An adhesive layer-equipped transparent plate, which comprises
a transparent plate, and
an adhesive layer provided on one surface of the transparent plate, wherein
the transparent plate is a plate glass having a plate thickness of from 0.4 to 3.0 mm, and
the adhesive layer has a storage shear modulus of at most 30 MPa at a temperature of 25° C. and at a frequency of 1 Hz, a storage shear modulus of at least 50 MPa at a temperature of 25° C. and at a frequency of 40 kHz, and a loss tangent tanδ of at least 0.1 at a temperature of 25° C. and at a frequency of 40 kHz.

2. An adhesive layer-equipped transparent plate, which comprises
a transparent plate, and
an adhesive layer provided on one surface of the transparent plate, wherein
the transparent plate is a plate glass having a plate thickness of from 0.6 to 3.0 mm, and
the adhesive layer has a storage shear modulus of at most 30 MPa at a temperature of 25° C. and at a frequency of 1 Hz, a storage shear modulus of at least 50 MPa at a temperature of 25° C. and at a frequency of 40 kHz, and a loss tangent tanδ of at least 0.1 at a temperature of 25° C. and at frequency of 40 kHz.

3. The adhesive layer-equipped transparent plate according to claim 1, wherein the plate glass is a tempered glass having a compressive stress layer, the thickness of the compressive stress layer is at least 15 μm, and the surface compressive stress in the compressive stress layer is at least 650 MPa.

4. The adhesive layer-equipped transparent plate according to claim 1, wherein the adhesive layer has a storage shear modulus of at most 15 MPa at a temperature of 25° C. and at a frequency of 1 Hz.

5. The adhesive layer-equipped transparent plate according to claim 1, wherein the adhesive layer has a storage shear modulus of at least 80 MPa at a temperature of 25° C. and at a frequency of 40 kHz.

6. The adhesive layer-equipped transparent plate according to claim 1, wherein the adhesive layer has an interfacial peel strength of at least 600 N/225 mm² at a tensile speed of 4 m/s.

7. The adhesive layer-equipped transparent plate according to claim 1, wherein the thickness of the adhesive layer is from 30 to 2,000 μm.

8. An adhesive layer capable of bonding a transparent plate and a display device, which has a storage shear modulus of at most 30 MPa at a temperature of 25° C. and at a frequency of 1 Hz, a storage shear modulus of at least 50 MPa at a temperature of 25° C. and at a frequency of 40 kHz, and a loss tangent tanδ of at least 0.1 at a temperature of 25° C. and at a frequency of 40 kHz.

9. The adhesive layer according to claim 8, which has a storage shear modulus of at most 15 MPa at a temperature of 25° C. and at a frequency of 1 Hz.

10. The adhesive layer according to claim 8, which has a storage shear modulus of at least 80 MPa at a temperature of 25° C. and at frequency of 40 kHz.

11. The adhesive layer according to claim 8, which has an interfacial peel strength of at least 600 N/225 mm² at a tensile speed of 4 m/s.

12. The adhesive layer according to claim 8, wherein the thickness of the adhesive layer is from 30 to 2,000 μm.
